(19) United States
(12) Patent Application Publication
(10) Pub. No.: US 2010/0047682 A1
(43) Pub. Date: Feb. 25, 2010

(54) BATTERY SYSTEM AND THERMAL MANAGEMENT SYSTEM THEREFOR

(75) Inventors: Gary P. Houchin-Miller, Milwaukee, WI (US); Steven J. Wood, Shorewood, WI (US); Dale B. Trester, Milwaukee, WI (US); Anthony Pacheco, Thiensville, WI (US); Steve Esshaki, Southgate, MI (US)

Correspondence Address: FOLEY & LARDNER LLP, 777 EAST WISCONSIN AVENUE, MILWAUKEE, WI, 53202-5306, US

(73) Assignee: Johnson Controls - SAFT Advanced Power Solutions, LLC

(21) Appl. No.: 12/545,022

(22) Filed: Aug. 20, 2009

Related U.S. Application Data
(63) Continuation-in-part of application No. PCT/US2008/055487, filed on Feb. 29, 2008.
Application No. PCT/US2008/055487 is a continuation-in-part of application No. PCT/US2008/056078, filed on Mar. 6, 2008.
(60) Provisional application No. 60/904,180, filed on Mar. 1, 2007.
(60) Provisional application No. 60/924,395, filed on May 11, 2007.
(60) Provisional application No. 60/905,309, filed on Mar. 7, 2007.
(60) Provisional application No. 60/905,309, filed on Mar. 7, 2007.
(60) Provisional application No. 60/924,395, filed on May 11, 2007.
(60) Provisional application No. 60/996,469, filed on Nov. 19, 2007.

(51) Int. Cl. H01M 10/50; H01M 6/46

(52) U.S. Cl. 429/120; 429/155

(57) ABSTRACT

A battery module includes a plurality of cells arranged in a battery pack. The battery pack includes a first tray configured to receive a first row of cells and a second row of cells. A second tray is provided over the first tray, the first row of cells, and the second row of cells. The second tray is configured to receive a third row of cells and a fourth row of cells. A third tray is provided over the second tray, the third row of cells, and the fourth row of cells. The first row of cells and the second row of cells are arranged between the first tray and the second tray and the third row of cells and the fourth row of cells are arranged between the second tray and third tray.

### CROSS-REFERENCE TO RELATED PATENT APPLICATIONS

This application is a Continuation-in-Part of International Patent Application No. PCT/US2008/055487, filed Feb. 29, 2008, which claims priority to and the benefit of U.S. Provisional Patent Application 60/904,180, filed Mar. 1, 2007 and U.S. Provisional Patent Application No. 60/924,395, filed May 11, 2007. This application is also a Continuation-in-Part of International Patent Application No. PCT/US2008/056078, filed Mar. 6, 2008, which claims priority to and the benefit of U.S. Provisional Patent Application 60/905,309, filed Mar. 7, 2007; U.S. Provisional Patent Application No. 60/924,395, filed May 11, 2007; and U.S. Provisional Patent Application 60/996,469, filed Nov. 19, 2007.

The disclosures of the following patent applications are incorporated herein by reference in their entirety: International Patent Application No. PCT/US2008/055487; International Patent Application No. PCT/US2008/056078; U.S. Provisional Patent Application 60/904,180; U.S. Provisional Patent Application 60/905,309; U.S. Provisional Patent Application No. 60/924,395; and U.S. Provisional Patent Application 60/996,469.

### BACKGROUND

The present application relates generally to the field of batteries and battery systems. More specifically, the present application relates to a system for packaging and cooling and/or heating batteries (e.g., in a cell assembly or module).

It is known to provide batteries for use in vehicles such as automobiles. For example, lead-acid batteries have been used in starting, lighting, and ignition applications. More recently, hybrid vehicles have been produced which utilize a battery (e.g., a nickel metal hydride (NiMH) battery, a lithium-ion battery) in combination with other systems (e.g., an internal combustion engine) to provide power for the vehicle. Additionally, vehicles have been produced which utilize only a battery (e.g., a NiMH battery, a lithium-ion battery) to provide power for the vehicle.

The design and management of a battery system and/or module that can be advantageously utilized in a hybrid or electric vehicle may involve considerations such as battery arrangement, electrical performance monitoring, thermal management, and containment of effluent (e.g., gases that may be vented from a battery cell).

It would be desirable to provide an improved battery module or system for use in vehicles. It would also be desirable to provide a system for efficiently and effectively cooling and/or heating battery cells used in the module. It would also be desirable to provide an improved system and method for assembling and arranging a battery module. It would be desirable to provide a battery system that includes any one or more of these or other advantageous features as will be apparent from the present disclosure.

### SUMMARY

According to an embodiment of the invention, a battery module includes a plurality of cells arranged in a battery pack. The cells have a first terminal and a second terminal at a first end thereof. The battery pack includes a first tray configured to receive a first row of cells and a second row of cells. A second tray is provided over the first tray, the first row of cells, and the second row of cells. The second tray is configured to receive a third row of cells and a fourth row of cells. A third tray is provided over the second tray, the third row of cells, and the fourth row of cells. The first row of cells and the second row of cells are arranged between the first tray and the second tray with the terminals of the first row of cells facing away from the terminals of the second row of cells and the third row of cells and the fourth row of cells are arranged between the second tray and third tray with the terminals of the third row of cells facing away from the terminals of the fourth rows of cells.

According to another embodiment of the invention, a method of managing the temperature of a plurality of cells within a battery module includes directing a fluid past a device configured to modify the temperature of the fluid. The fluid is directed into an inlet of the battery module such that the fluid flows proximate the plurality of cells to modify the temperature of the cells. The device is configured such that the fluid enters the inlet at a first temperature during a first period and at a second temperature during a second period, the first temperature being different from the second temperature. The temperature difference between a first group of cells closest to the inlet and a second group of cells furthest from the inlet is less than it would be if the fluid were provided into the battery module at a constant temperature.

According to another embodiment of the invention, a method of controlling the temperature of a plurality of cells in a battery module includes thermally conditioning a fluid using a thermal management device. The thermally conditioned fluid is forced over the plurality of cells using a fan. The fan is configured to operate at a plurality of different speeds. The speed of the fan is changed at predetermined intervals and by predetermined amounts to change the temperature of the fluid.

According to another embodiment of the invention, a method of controlling the temperature of a plurality of cells within a battery module includes flowing a fluid past a thermal management device configured to modify the temperature of the fluid. The fluid is forced into the module and past the cells using a fan. The thermal management device and the fan speed are changed to control the temperature of the fluid entering the module so as to control the amount of temperature variation between individual cells in the module.

### BRIEF DESCRIPTION OF THE DRAWINGS

FIG. 1 is a perspective view of a vehicle having a battery module provided therein.

FIG. 2 is a perspective view of a vehicle according to another exemplary embodiment.

FIG. 3 is a perspective view of a battery module or system according to an exemplary embodiment.

FIG. 4 is a perspective view of a housing or cover for use with a battery module such as that shown in FIG. 3.

FIG. 5 is an exploded perspective view of a battery module or system according to an exemplary embodiment.

FIG. 6 is a perspective view of a battery pack for use with a battery module or system such as that shown in FIG. 5.

FIG. 7 is an exploded perspective view of the battery pack of FIG. 6.

FIG. 8 is a partially exploded perspective view of a battery pack for use in a battery module according to an exemplary embodiment.

FIG. 9 is a perspective view of the assembled battery pack of FIG. 8.

FIG. 10 is a front elevation view of the assembled battery pack of FIG. 8.

FIG. 11 is an exploded perspective view of the battery pack of FIG. 8 with three rows of cells omitted.

FIG. 12 is a perspective view of a tray of the battery pack of FIG. 7.

FIG. 13 is a detailed perspective view of the tray of FIG. 12.

FIG. 14 is a plan view of the buss bar assemblies and cell supervisory controllers of the battery module shown in FIG. 6.

FIG. 15 is a detailed perspective view of the buss bar assembly of FIG. 14.

FIG. 16 is a perspective view of a high voltage link cover for the buss bar assembly according to an exemplary embodiment.

FIG. 17 is an exploded perspective view of the high voltage link cover of FIG. 16.

FIG. 18 is a rear perspective view of the high voltage link cover of FIG. 16.

FIG. 19 is an exploded perspective view of the high voltage link cover of FIG. 18.

FIG. 20 is a partially exploded view of the battery module of FIG. 4.

FIG. 21 is another perspective view of the battery module of FIG. 4.

FIG. 22 is a cross sectional view of the battery pack of FIG. 9.

FIG. 23 is a detailed cross sectional view of the battery pack of FIG. 22.

FIG. 24 is a partial cut away cooling flow diagram of the battery pack of FIG. 9.

FIG. 25 is a perspective view of a battery module or system according to another exemplary embodiment.

FIG. 26 is a top view of the battery module of FIG. 25.

FIG. 27 is a perspective view of the battery module of FIG. 1 including a fan and a thermal management device according to an exemplary embodiment.

FIG. 28 is a graph illustrating the heating temperature response for several groups or rows of battery cells according to an exemplary embodiment.

FIG. 29 is a graph illustrating the heating temperature response for several groups or rows of battery cells according to another exemplary embodiment.

FIG. 30 is a graph illustrating the heating temperature response for several groups or rows of battery cells according to another exemplary embodiment.

### DETAILED DESCRIPTION

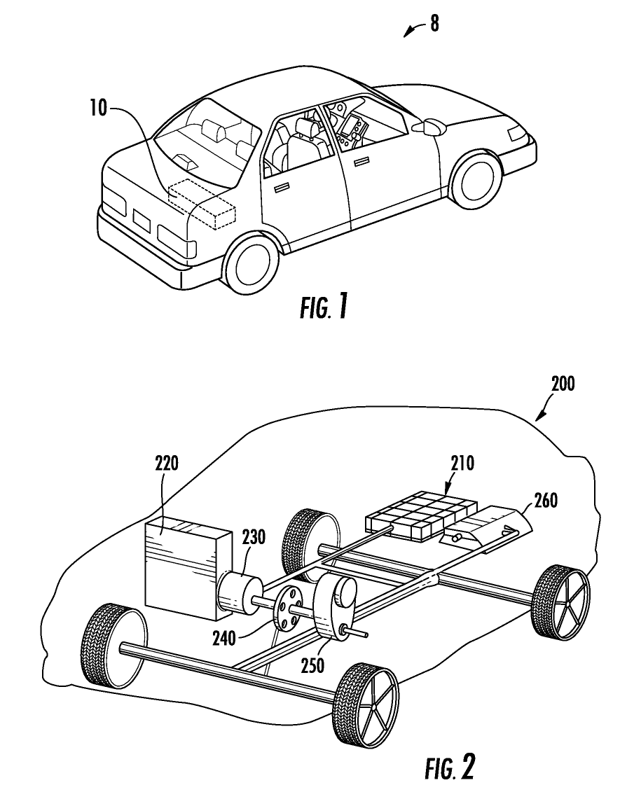

The batteries and systems described herein may be used in any of a variety of applications, including, for example, vehicles such as hybrid electric vehicles, plug-in electric vehicles, and electric vehicles. FIG. 1 is a perspective view of a vehicle 8 (e.g., a hybrid-electric vehicle (HEV), plug-in HEV (PHEV), or electric vehicle (EV)) having a battery module provided therein according to an exemplary embodiment. According to an exemplary embodiment, the vehicle is a hybrid electric or electric vehicle. The size, shape, and location of the battery module or system and the type of vehicle may vary according to a variety of other exemplary embodiments. For example, while the vehicle in FIG. 1 is shown as an automobile, according to various alternative exemplary embodiments, the vehicle may comprise a wide variety of differing types of vehicles including, among others, motorcycles, buses, recreational vehicles, boats, and the like. Additionally, it should be understood that the module 10 may be oriented in any suitable direction as may be appropriate in a given vehicle application.

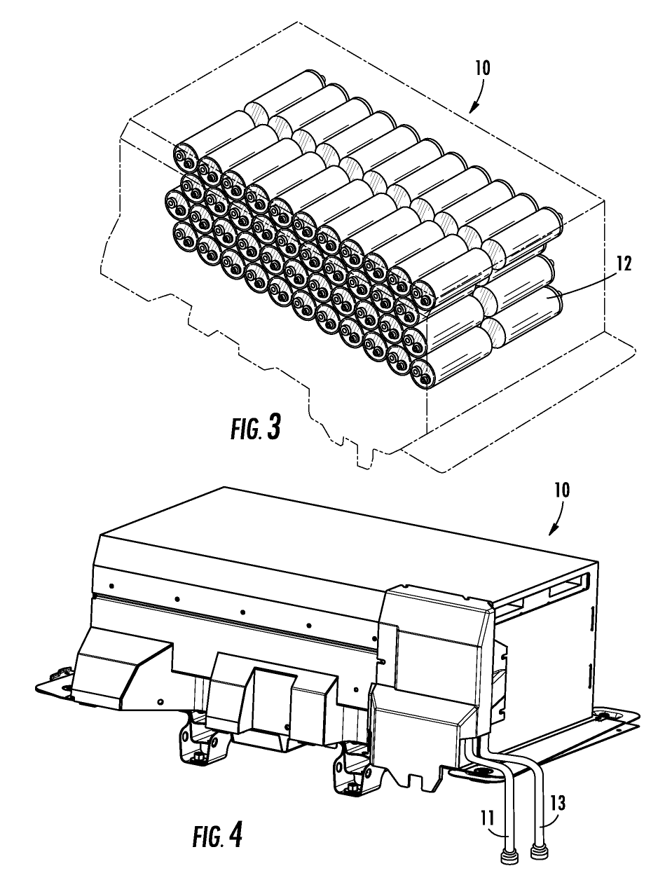

One example of the manner in which the battery system or module is integrated within a vehicle is illustrated according to an exemplary embodiment illustrated in FIG. 2. As shown therein, a vehicle 200 (e.g., an HEV) is shown according to an exemplary embodiment. Vehicle 200 includes a battery system 210 (e.g., lithium-ion battery system), an internal combustion engine 220, an electric motor 230, a power split device 240, a generator 250, and a fuel tank 260. Vehicle 200 may be powered or driven by just the battery system 210, by just the engine 220, or by both the battery system 210 and engine 220. It should be noted that other types of vehicles and configurations for the vehicle electrical system may be used according to other exemplary embodiments.

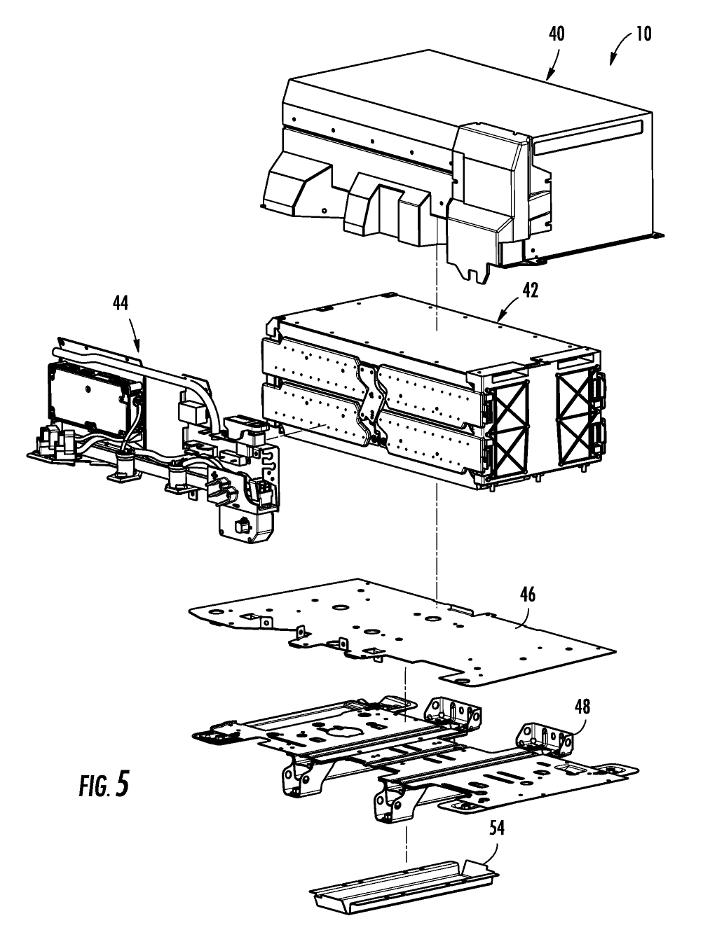

Referring to FIGS. 3-5, a battery system or module 10 is shown to include a housing 40, a battery pack 42, a battery disconnect unit 44, a base member shown as base plate 46, a support member shown as support frame 48, and a cover member shown as under mount cover 54. The housing 40 is configured to encase or enclose the battery pack 42 and the battery disconnect unit 44. The housing 40 may be constructed of a single sheet of material (e.g., sheet metal) or may be constructed of various combinations of different types of materials (e.g., metal, plastic, etc.). As shown in FIG. 5, the housing 40 is closed on five sides and open on a bottom side. In other embodiments, housing 40 may be closed on the bottom side and have an opening on a side elsewhere on housing 40. Connectors 11, 13 (e.g., a low voltage 16-pin connector, a low voltage 24-pin connector, etc.) are provided coupled to module 10.

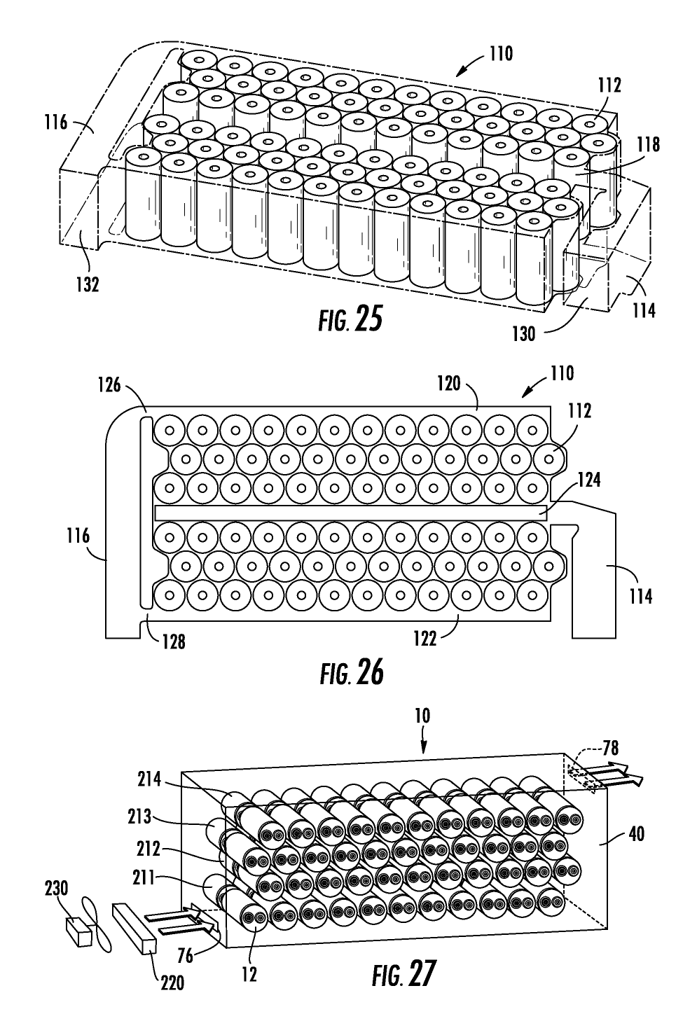

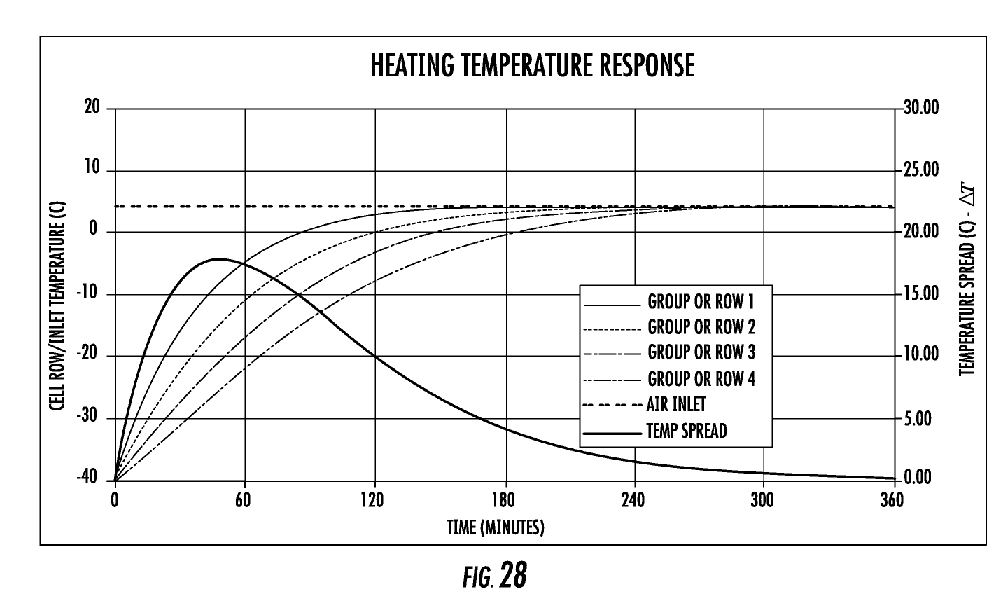

Provided in battery pack 42 are a plurality of batteries or cells 12 (as shown, for example, in FIG. 3). Cells 12 are shown in FIG. 3 as being provided in a generally horizontal manner. Alternatively, cells 12 may be provided in a generally vertical manner (as shown in FIG. 25).

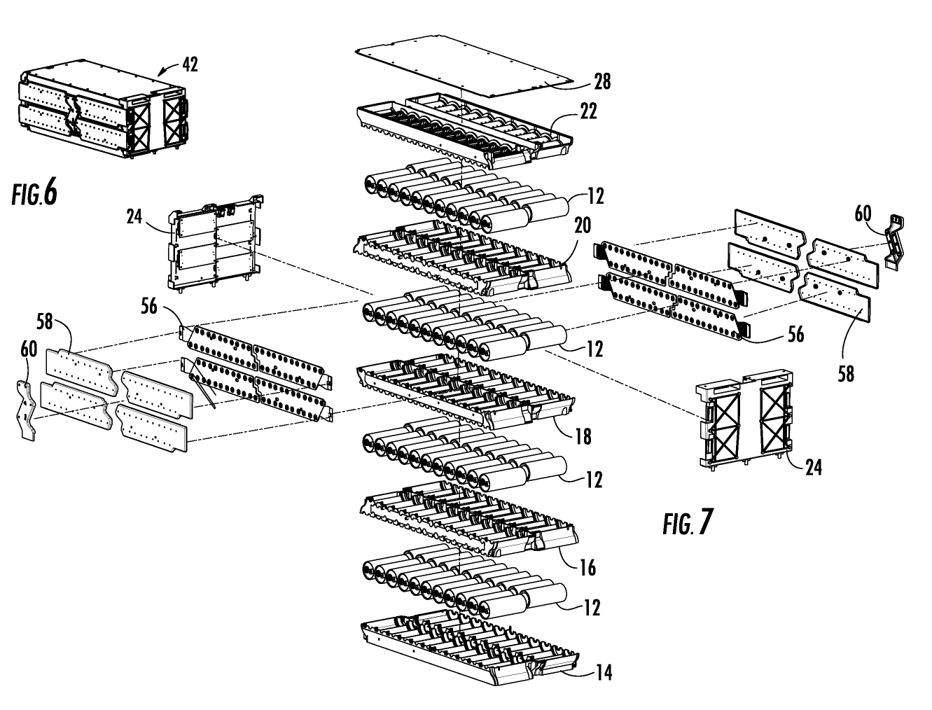

Referring to FIGS. 6 and 7, battery pack 42 is shown to include a plurality of cells 12, a plurality of trays 14, 16, 18, 20 and 22, a first cell supervisory controller (CSC) 24, a second cell supervisory controller 26, a member shown as top tray plate 28, a plurality of buss bar assemblies 56, a plurality of buss bar covers 58, and a plurality of high voltage link cover assemblies 60.

Referring to FIGS. 8-11, a battery pack 42 (only one-half of battery pack 42 is shown for clarity) includes a plurality of batteries or cells 12 and a plurality of members or elements shown as trays 14, 16, 18, 20, and 22. Between each of the trays 14, 16, 18, 20, and 22 is provided a row of cells 12 (as shown, for example, in FIG. 11, where one row of cells 12 is provided in tray 14; the other rows of cells have not been shown between the trays for clarity) such that the trays sandwich the cells therebetween.

Each of the trays 14, 16, 18, 20, and 22 are configured to receive a row of battery cells 12. Each of the batteries 12 in the row fit into or are received by a depression, valley, trough, cradle, or channel 15 and an upper portion, protrusion, ridge or peak 17 defined by the trays 14, 16, 18, 20, and 22 (see, for example, tray 20 in FIG. 11—similar configurations are provided for each of the trays).

The tray 16, which has a different configuration than tray 14 as shown in FIG. 11, is provided on top of the first row of cells 12 and is configured for coupling or mating with the tray 14 to retain the row of cells 12 in place. A second row of cells 12 is then provided on tray 16 in the depressions or channels defined by the tray 16.

The tray 18 is configured for mating or coupling both with tray 16 and to sandwich the second row of cells between the trays 16 and 18. A third row of cells 12 is provided on tray 18.

Tray 20 is configured for coupling or mating with the tray 18 and for sandwiching the third row of cells between the trays 18 and 20. A fourth row of cells 12 is provided on tray 20.

Tray 22, which has a similar or identical configuration to tray 14, is configured for coupling or mating with tray 20 and for sandwiching the fourth row of cells 12 between trays 20 and 22.

According to an exemplary embodiment, the trays 14 and 22 have a similar or identical configuration. According to an exemplary embodiment, the trays 16, 18, and 20 have a similar or identical configuration. As shown in FIG. 11, the trays 16, 18, and 20 are arranged in alternating orientations (i.e., the trays are arranged as mirror images of each other in the battery pack 42).

It should be understood that according to other exemplary embodiments, the battery module may include any suitable number of rows of batteries or cells and any suitable number of trays of any desired configuration.

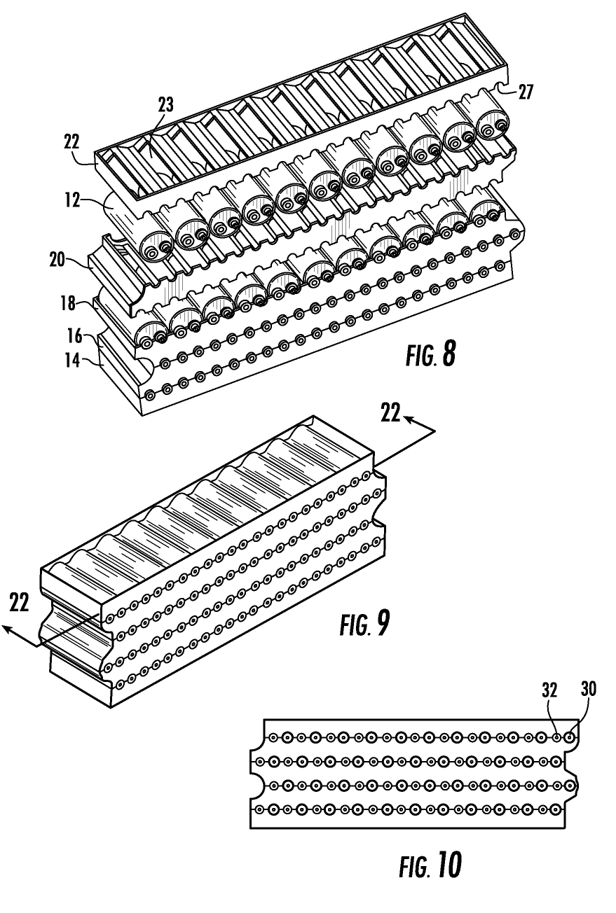

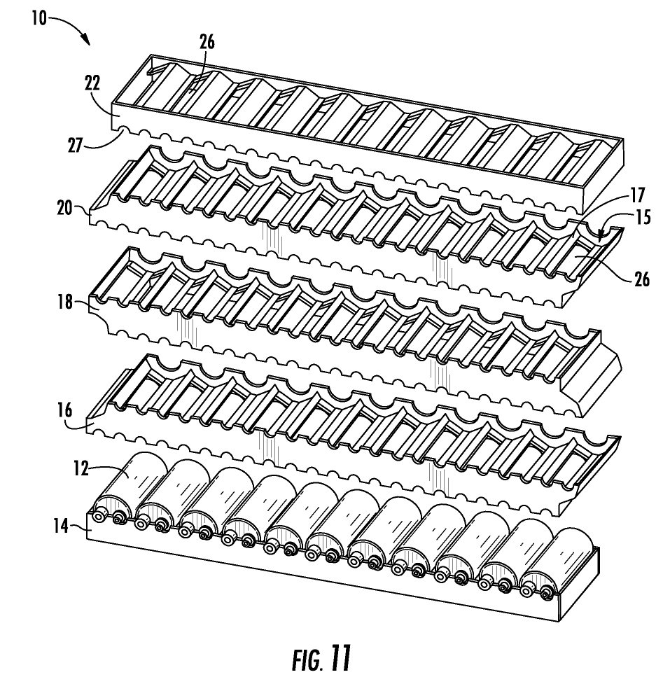

The terminals 30, 32 of cells 12 (as shown in FIG. 10) are exposed for relatively easy access for connecting to a load or to each other. The opposite end of each battery or cell 12 is exposed on the opposite side of the trays as a pathway for the expulsion of gases in the event that a cell 12 should expel gasses or effluent.

Each tray 14, 16, 18, 20, and 22 also defines a number of cutouts, openings or grooves 27 (shown in FIGS. 11-13) for the terminals 30, 32 (shown in FIG. 10) of each cell 12 to be exposed when module 10 is assembled. Cutouts, openings, or grooves 27 are typically of a specific shape to facilitate proper polarity of the terminals 30, 32 when laying down a row of cells 12 (for example, since the terminals have different sizes and/or shapes, the cells must be oriented in a particular manner in order for the terminals to be properly received in the grooves in a Poka-Yoke manner). In other exemplary embodiments, grooves 27 may be of shapes that are capable of receiving a plurality of different shapes of terminals regardless of polarity.

Each tray 14, 16, 18, 20, and 22 includes one or more cutouts or openings 26 that are configured to facilitate a flow of a fluid 36 (for example, air, liquid, etc.) between the cells 12 of battery pack 42. Openings 26 of trays 14, 16, 18, 20, and 22, when stacked or assembled, define paths or channels 34 (as shown in FIG. 22). Channels 34 are located both before and after the cells 12 to aid in either cooling or heating the cells 12.

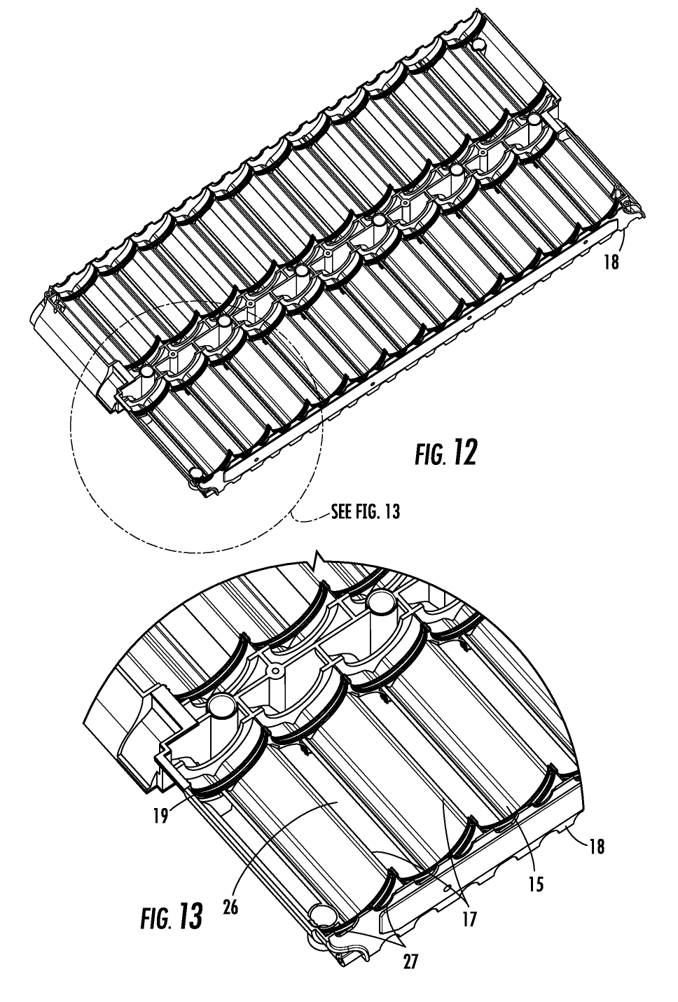

Referring now to FIGS. 12-13, a tray 18 is shown according to another exemplary embodiment to include a sealing member 19. Any of the above described trays may further include sealing member 19 as shown in FIGS. 12-13. According to one exemplary embodiment, sealing member 19 is an overmolded silicone seal that is configured to resist high temperatures. Sealing member 19 facilitates isolating fluid 36 in discrete channels and keeps the fluid 36 isolated from the terminals 30, 32 of the cells 12 and any gasses that might be vented from the cells 12. Sealing member 19 may also aid in dampening any vibrations the battery module 10 is exposed to, thus protecting individual cells 12.

FIG. 7 illustrates a battery pack 42 capable of retaining eighty-eight cells 12. It should be understood that in other exemplary embodiments, a different number of cells may be utilized in the module, depending on the number of trays 14, 16, 18, 20, and 22 used and other factors. For example, a base tray (such as tray 14) may be combined with a top tray (such as tray 22) while omitting other trays (for example trays 16, 18, and 20) resulting in a module 10 with a single row of cells 12. In another example, a base tray (such as tray 14) may be combined with a single tray (for example, tray 16) and a top tray (such as tray 22), resulting in a module 10 with two rows of cells 12. In still other examples, modules of greater size than shown in FIGS. 7-13 may be assembled by adding alternating layers of trays such as those shown in FIGS. 7-13 as appropriate. Likewise, trays 14, 16, 18, 20, and 22 may be of different sizes and have capacity for more or fewer than eleven cells in each row. Additionally, each individual tray 14, 16, 18, 20, and 22 may be able to receive more then one or two rows of cells. For instance, each individual tray 14, 16, 18, 20, and 22 may be able to receive three or more rows of cells. It should be noted that FIG. 7 shows trays 14, 16, 18, 20, and 22 that are not shown interspersed between cells 12 for clarity. Trays 14, 16, 18, 20, and 22 may be interspersed between cells 12 as discussed above.

Trays 14, 16, 18, 20, and 22 may be made of any generally electrically insulating material (e.g., an injected molded polymeric material such as polyethylene or polypropylene) capable of supporting the cells 12 in a configuration similar to that shown in FIGS. 7-13. Additionally, while the cells shown in FIGS. 7-11 are shown as having a generally cylindrical shape, according to other exemplary embodiments, cells may have other forms (for example, oval, prismatic, polygonal, etc.). According to still other exemplary embodiments, cells may be lithium-ion, nickel cadmium, nickel metal hydride (NiMH), or any other suitable types of electrochemical cells.

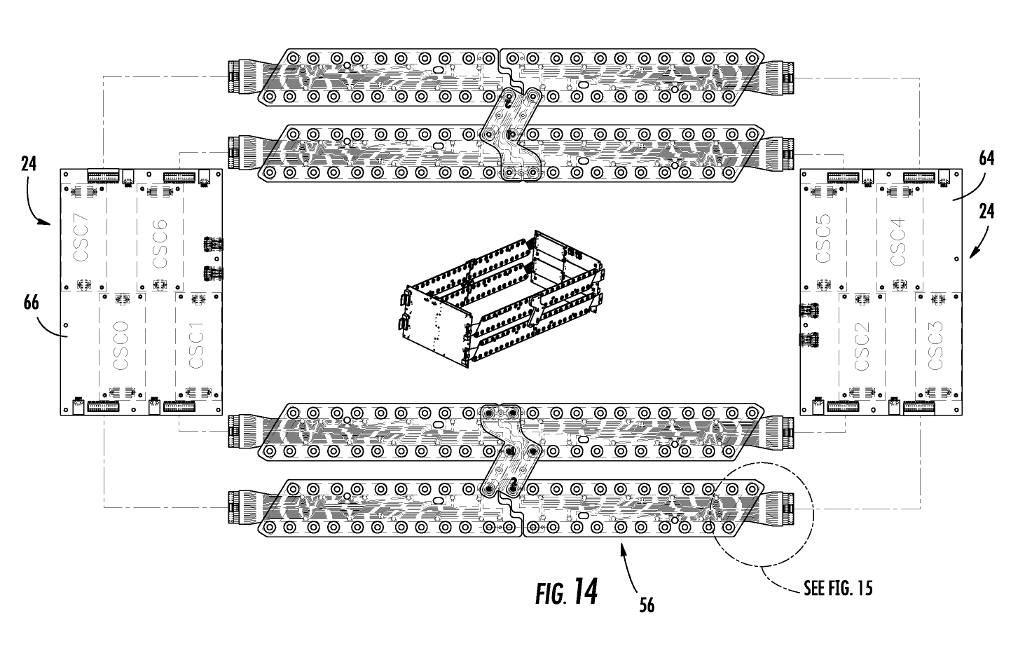

Referring to FIGS. 14-15, the plurality of buss bar assemblies 56 are shown arranged to be assembled to the battery pack 42. The buss bar assembly 56 is shown to include a plurality of holes to be inserted over the terminals 30, 32 of the cells 12. Buss bar assembly 56 includes a plurality of connectors or buss bars that are riveted or otherwise coupled to a generally nonconductive substrate by fastening members (not shown). The buss bars are configured to couple the terminals of adjacent cells together or to an outside connector. Buss bar assembly 56 may further include sensors (e.g., voltage sensors, temperature sensors, etc.) that are coupled to the substrate of the buss bar assembly and are in communication with the cells 12 via sensor wires that are integrated onto the substrate of the buss bar assembly 56. The sensors may be electrically coupled to the buss bars and may monitor battery pack 42. Buss bar assembly 56 may also include one or more connectors (e.g., the connector shown as multi-pin connector 62 in FIG. 15).

The integrated nature of the buss bar assembly 56 (i.e., combining the buss bars, sensors, sensor wires, and connectors into a single component) reduces the overall parts count of the battery pack 42 (and the battery module 10) and simplifies assembly of the battery pack 42. For example, instead of having to assemble multiple components (e.g., individual buss bars, sensors, wires, etc.) to the battery pack 42, a single buss bar assembly 56 (having all the individual components attached to the buss bar assembly) is instead coupled to a battery pack 42 in a single action.

Also shown in FIG. 14 is a first cell supervisory controller 24 and a second cell supervisory controller 26. The cell supervisory controllers 24, 26 are shown to include a member shown as trace board 64, 66. The function of the cell supervisory controller is to monitor the individual cell temperature and voltage, perform cell balancing and provide (redundant) overvoltage protection. The cell supervisory controller is in electrical communication with the plurality of cells 12 via connector 62 shown in FIG. 15.

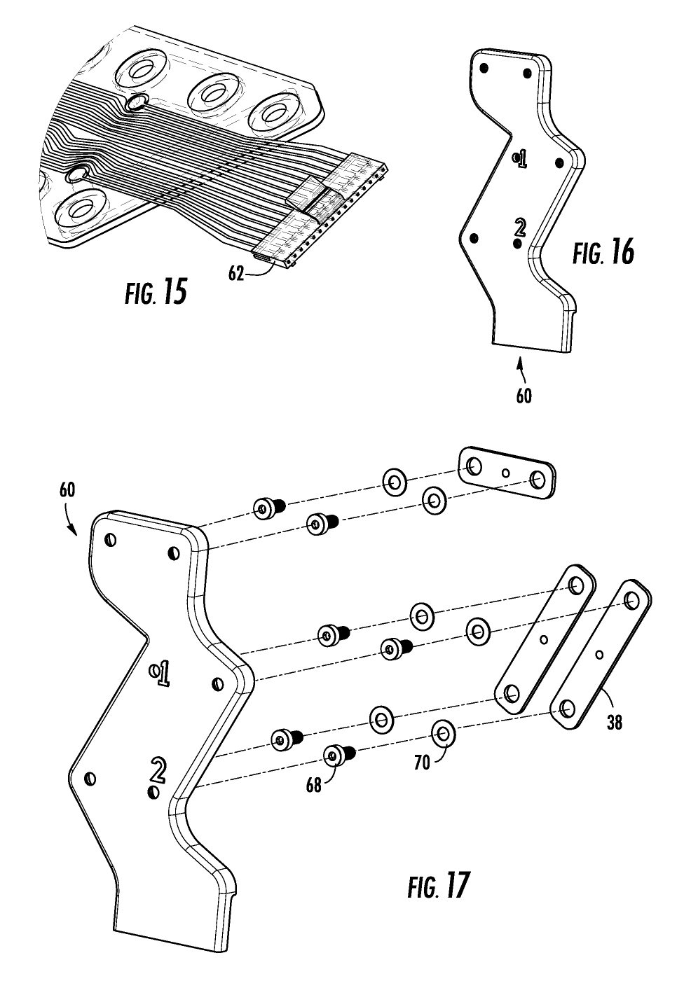

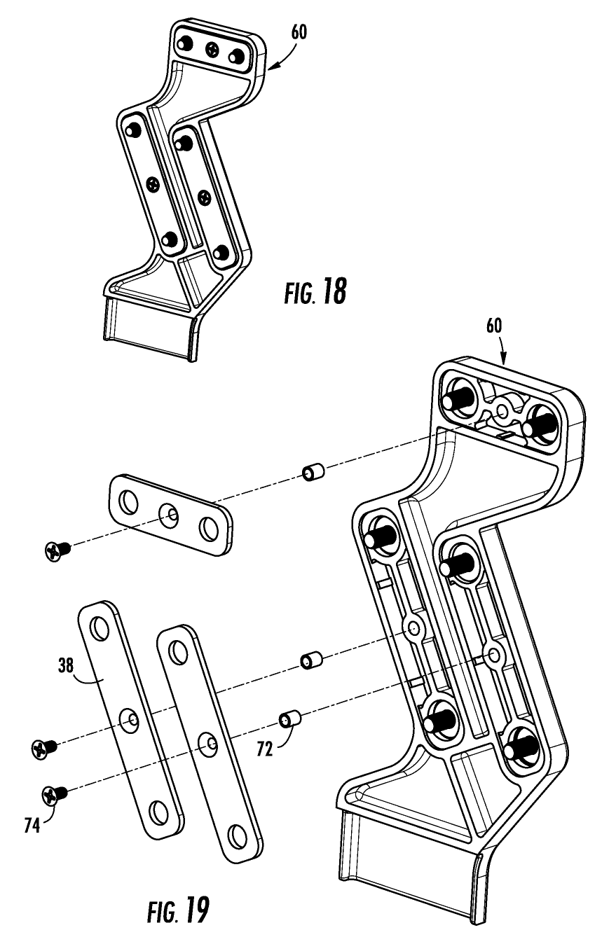

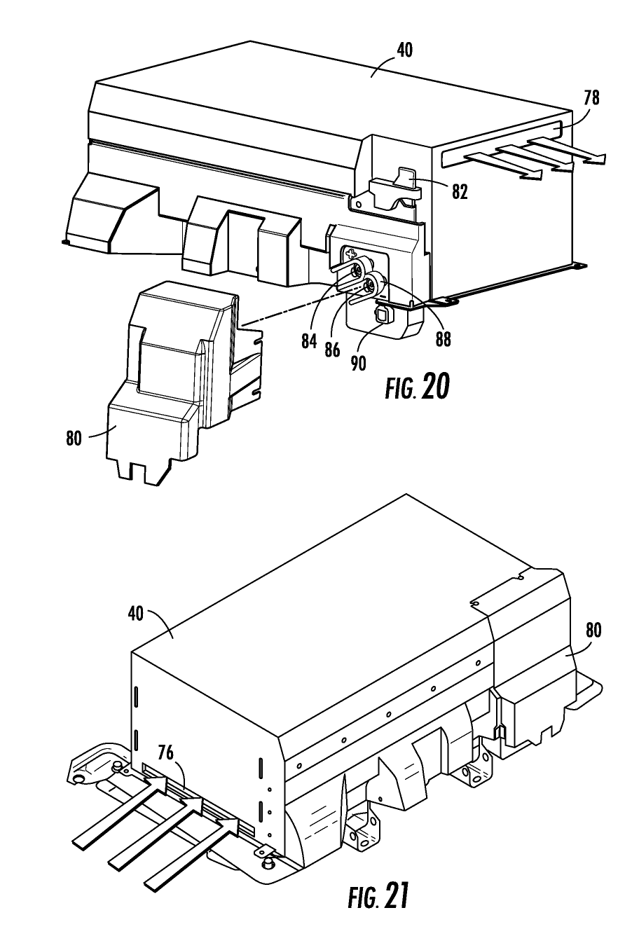

Referring to FIGS. 16-19, a high voltage link cover 60 is shown according to an exemplary embodiment. The high voltage link cover 60 is shown to include fastener 68, 74, washers 70, and buss bars 38. The function of high voltage cover 60 is to cover the high voltage terminals of the battery pack 42. As one of the final steps of assembly, the cover 60 with integrated High Voltage (HV) links is attached across the separate buss bar sections to create an HV system. This step allows most pack assembly to be done in a safer, lower-voltage environment and minimizes the assembly work done with bulky protective equipment.

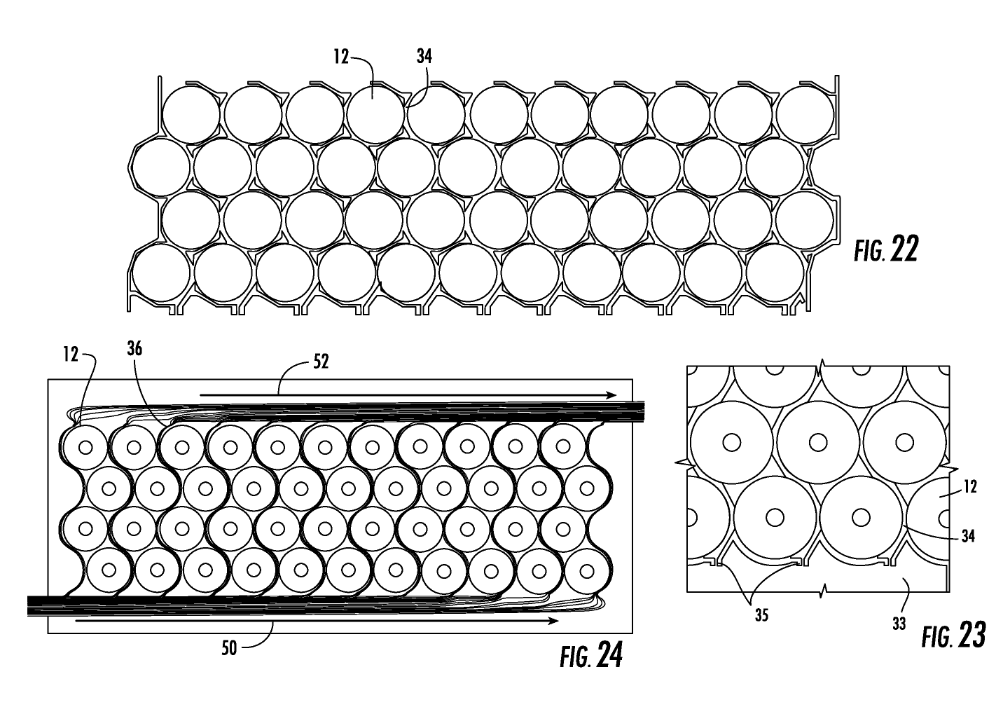

Referring to FIGS. 20 and 21, housing 40 is shown to include a first opening 76, a second opening 78, and a member shown as terminal cover 80. The terminal cover 80 covers the main terminal of battery module 10 (shown as first terminal 84 and second terminal 86), a service disconnect 82 and a high voltage charger connector 90. Also provided on housing 40 is a raised member shown as protrusion 88. Protrusion 88 may be shaped in the general shape of a numeral 3. The function of protrusion 88 is to keep main terminals 84, 86 separated from one another while connecting main terminals of battery module 10 to a vehicle. Protrusion 88 is helpful in guiding connecting cables (not shown) when connecting battery module 10 to a vehicle.

Referring to FIGS. 22-24, an assembled battery pack 42 defines a number of discrete channels, pathways, or passages 34 (through openings in the trays as described above) for the flow of a fluid 36 (for example, air, gas, water, liquid, etc.) near and around cells 12. As shown specifically in FIG. 24, fluid 36 may be provided to battery pack 42 to aid in cooling or heating the cells 12. Fluid 36 may enter battery pack 42 as represented by arrow 50 in FIG. 24. Alternatively, fluid 36 may enter battery pack 42 in the reverse direction to that shown in FIG. 24 (i.e., fluid 36 may enter battery pack 42 at arrow 52 and exit at arrow 50). Fluid 36 may be at a high velocity or any other suitable velocity.

As shown in more detail in FIG. 23, the fluid 36 flows from a plenum airspace 33 through features shown as openings, inlets or bottlenecks 35 to a multitude of discrete channels, pathways, or passages 34 formed between cells 12 and trays 14, 16, 18, 20, and 22. The bottlenecks 35 form a restricted opening that creates a pressure drop as the fluid 36 leaves the plenum airspace 33. Having bottlenecks 35 ensures that fluid reaches all the discrete channels 34 at substantially the same temperature. As the fluid 36 flows over cells 12, heat transfer takes place (i.e., the fluid 36 absorbs heat from cells 12 or the fluid 36 provides heat to the cells 12) and the fluid 36 exits battery pack 42. Confining the fluid 36 to discrete channels reduces the chance of the fluid taking unpredictable or undesirable paths through the module 10. Additionally, confining the fluid 36 to discrete channels further allows greater control of the heat transfer characteristics of the system.

During cooling, exiting fluid 36 may be at a higher temperature than entering fluid 36 due to the heat transfer that takes place between the cells 12 and the fluid 36. Alternatively, during heating, exiting fluid 36 may be at a lower temperature than entering fluid 36 due to the heat transfer that takes place between the cells 12 and the fluid 36. It is noted that according to various exemplary embodiments, fluid 36 may be pushed into (blown into) or pulled through (sucked out of) module 10 (for example, by a fan, by a pressure difference, by a vacuum pump, etc.).

It is noted that while a specific shape of pathways 34 is shown, pathways of other shapes may be defined based on alternative tray structures and shapes. As shown previously, cells 12 lie in or make contact with trays 14, 16, 18, 20, and 22. In an exemplary embodiment where trays 12, 16, 18, 20, and 22 are at least partially thermally conductive, contact with the material may transport heat from the cells to a state of equilibrium, thus moderating the temperature of individual cells 12 with the temperature of other cells.

Referring to FIGS. 25 and 26, a battery module 110 is shown according to an exemplary embodiment. Battery module 110 is shown to include a plurality of batteries or cells 112 arranged in a generally vertical configuration. A central plenum 118 is provided between a first grouping of cells 112 and a second grouping of cells 112. A first exterior plenum 120 is provided exterior the first grouping of cells 112 and a second exterior plenum 122 is provided exterior a second grouping of cells 112. A duct 114 is shown connected to a central plenum 118. A duct 116 is shown connected to the external plenums 120, 122 via ports or openings 126, 128. Duct 114 has an opening 130 and duct 116 has an opening 132.

As shown in FIG. 26 a thermal management device (e.g., a heater, a cooling device) 124 is provided in central plenum 118. Alternatively, a thermal management device 124 may be provided in a different location other than that shown in FIG. 26, or not at all. For instance, a thermal management device may be placed in duct 114 or in duct 116. Fluid flow through battery module 110 may be from duct 114, into the central plenum 118, and then through the cells 112 (in both directions). Fluid will then exit through external plenums 120, 122 and out duct 116. Alternatively, fluid flow may begin at duct 116 and enter battery module 110 through the external plenums 120, 122. Fluid will then flow through the cells 112 and then exit through the central plenum 118 and out duct 114. A fluid may be used to either heat or cool battery module 110.

Thermal management systems (e.g., a fan and a heating device, a fan and a cooling device) that provide thermally conditioned (e.g., heated, cooled) fluid across a number of individual battery cells that are a part of the battery module can cause large temperature variations among and within the battery cells, particularly in applications where the thermally conditioned air passes across the cells that are arranged in groups or rows (e.g., thermally conditioning a first group or row of cells, then a second group or row of cells, and so on, where the thermally conditioned air is modified by the cells as it passes over subsequent groups or rows of cells). Furthermore, temperature differentials between battery cells may result from incomplete thermally conditioning processes, for example, if the thermally conditioning process is interrupted (e.g., as a result of a user stopping the thermally conditioning process to start and operate a vehicle). Additionally, the thermal mass of the cells and the battery system may often sustain any temperature variation between the cells for a substantial period of time.

Large temperature variations sustained during vehicle operation can result in damage to the individual batteries or cells. For example, differences in cell temperatures within battery modules may cause difficulties with battery system life by aging cells differently.

Accordingly, it would be advantageous to provide a system and method for thermally conditioning a battery module that minimizes the temperature variation between battery cells throughout the thermal conditioning process.

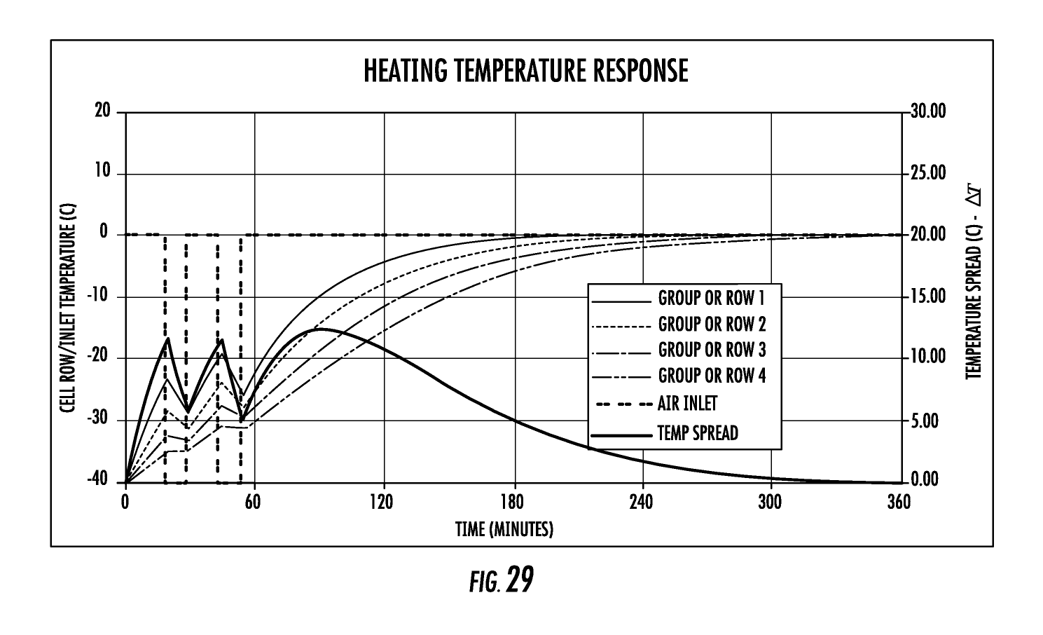

Referring to FIG. 27, a battery module 10 is shown according to an exemplary embodiment. The battery module 10 includes a plurality of electrochemical cells or batteries 12 (e.g., lithium-ion batteries, nickel-metal-hydride batteries, lithium polymer batteries, etc.). The cells 12 are surrounded by an outer casing or housing 40 that includes a first opening 76 (e.g., an inlet) and a second opening 78 (e.g., an outlet). Housing 40 may act as one or both of an inlet plenum and an outlet plenum for the battery module 10. Alternatively, battery pack 42 (as shown in FIG. 5) may act as one or both of an inlet plenum and an outlet plenum for the battery module 10.

The openings 76, 78 permit fluid (e.g., air, gas, water, liquid) to flow through the inside of the housing 40 and over the cells 12 to cool or warm the cells 12. FIGS. 24 and 27 show an exemplary arrangement for a battery pack 42 with cross-flow (e.g., such that the fluid flows perpendicular to the longitudinal axes of the battery cells) heating/cooling of cells 12 such that the fluid flows over the first group or row of cells, then the second group or row of cells, and so on.

Referring to FIG. 27, there are four rows of cells 12 provided (e.g., stacked, arranged, etc.) above each other (i.e., a first group or row 211, a second group or row 212, a third group or row 213, and a fourth group or row 214). A thermal management device 220 (e.g., a heater, a cooler, etc.) may be placed at the opening 76, and the fluid path can be used to warm or cool the cells 12. A fan 230 blows fluid over the thermal management device 220, forcing heated or cooled fluid into the housing 40 through the opening 76.

According to one exemplary embodiment shown in FIG. 27, the thermal management device 220 is provided near (e.g., at, proximate, adjacent, etc.) the opening 76. According to another exemplary embodiment, the thermal management device 220 may be connected to or provided as a part of the surface of the inlet plenum (e.g., the lower portion of the housing 40 shown in FIG. 27). If the thermal management device 220 is connected to or provided as a part of the plenum surface, it may be used to provide heat or cooling to the cells 12 without the fan 230 being on for a portion of a heating cycle or cooling cycle because the thermal management device 220 would be close enough to the cells 12 to provide heated or cooled fluid to the cells 12 without the need of a fan 230 to force the fluid over the cells 12.

FIG. 28 illustrates the heating curves of a group of cells 12 when heated according to a method in which the fluid is air, the thermal management device 220 is a heater and is always on and the fan 230 is run at a constant speed. The heated air passes the first group or row of cells 211, then the second group or row of cells 212, and so on. As the heated air passes over the cells 12, it cools down as heat is transferred to the cells 12. Because of this, the cells 12 farther away from the opening 76 receive cooler air and less heat. FIG. 28 shows the temperature of the four groups or rows of cells 12, with the first group or row 211 being closest to the inlet and the fourth group or row 214 being farthest from the inlet (see FIG. 27).

FIG. 28 further shows the air inlet temperature (Inlet) and the temperature difference (ΔT) between the first group or row of cells 211 and the fourth group or row of cells 214. The cells 12 are heated from a temperature of −40 degrees Celsius to a temperature of 4 degrees Celsius. The temperature difference between the first group or row of cells 211 (corresponding to the lowest group or row of cells as shown in FIG. 27) and the fourth group or row of cells 214 (corresponding to the uppermost group or row of cells as shown in FIG. 27) increases relatively rapidly to approximately 18 degrees Celsius (at approximately 40 minutes) as the first group or row 211 is warmed by the incoming air much faster than the fourth group or row 214. The temperature difference slowly decreases as heat transfer between the cells 12 begins to equalize the temperatures of the cells 12 and all the cells 12 in the battery module 10 approach a temperature of 4 degrees Celsius.

The relatively large temperature difference early in the heating cycle is undesirable. A user may halt the heating cycle prematurely to use the vehicle 8 while the temperatures of the cells 12 are widely varying, which may result in damage or reduced life of some of the cells 12. Differences in cell temperatures within a battery system or battery module 10 may also cause problems with battery system life by causing cells 12 to age differently.

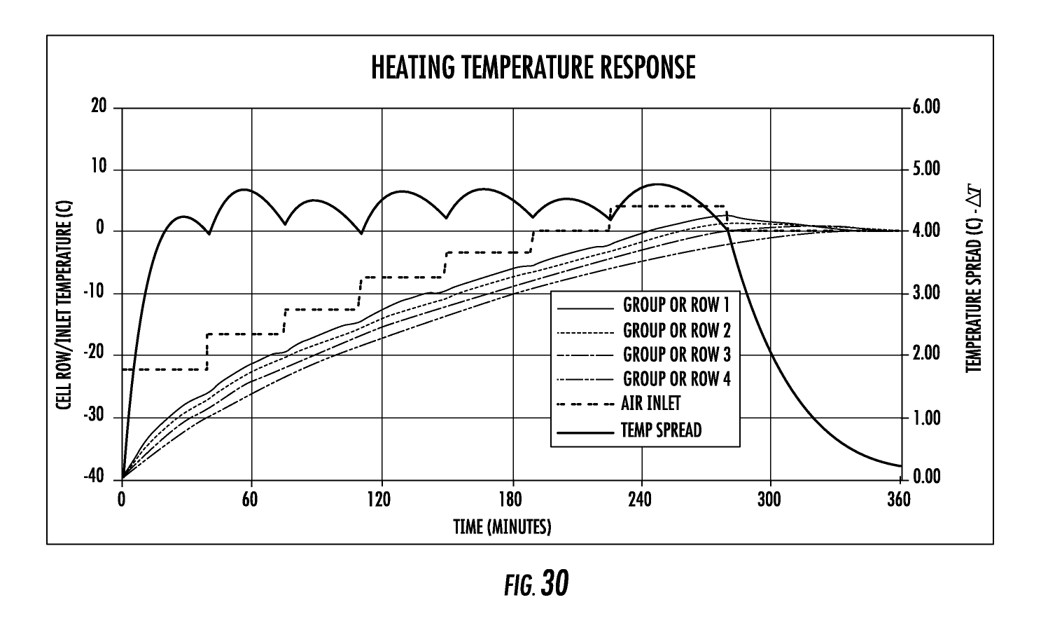

One exemplary embodiment of a method of heating a plurality of battery cells 12 such as that shown in FIG. 27 is reflected in the temperature curves illustrated in FIG. 29. According to the exemplary embodiment reflected in FIG. 29, the thermal management device 220 (in this case, a heater) is turned on and off intermittently (e.g., at intervals of 5 minutes, 10 minutes, 15 minutes, 20 minutes, 25 minutes, 30 minutes, 35 minutes, etc.) in the beginning of the heating cycle, changing the input fluid (in this case, air) temperature from one temperature (e.g., the desired final temperature) to another, lower temperature (e.g., the ambient temperature of the unheated outside air). When the thermal management device 220 is on, the fan 230 forces heated air over the cells 12, which causes the first group or row of cells 211 to warm faster than the group or row series 214. When the thermal management device 220 is turned off, the fan 230 forces cooler air over the cells 12, causing the first group or row of cells 211 to cool noticeably while the fourth group or row of cells 214 cools far less (e.g., as a result of the cooler air being warmed as it passes over the first/second/third group or row of cells 211, 212, 213).

After a predetermined period of time, the thermal management device 220 may be left on for the remainder of the heating process (e.g., after 40 minutes, 50 minutes, etc.). It is expected that this heating method will result in a lower maximum temperature difference between the cells than the method of FIG. 28 (e.g., as shown in FIG. 29, the maximum temperature difference is 12 degrees Celsius, while in FIG. 28, the maximum temperature difference is 18 degrees Celsius). The alternating streams of heated air and cooler (e.g., ambient) air serve to equalize the temperatures of the cells 12, and the resulting maximum temperature difference is reduced. Periodically forcing cold air over the cells 12 also reduces the temperature gradient between the outside surface of an individual cell 12 and the center of the cell 12 that may develop during the heating cycle, which may increase battery life.

While FIG. 29 reflects one exemplary embodiment of a heating process, according to other exemplary embodiments, the length of time the thermal management device 220 is turned on and off may be changed to heat the cells 12 more quickly or to reduce the temperature difference between the cells, depending on the particular application. Furthermore, rather than turning the thermal management device 220 on and off, the thermal management device 220 may remain on and be cycled between a first (higher) temperature and a second (lower) temperature. Alternatively, the thermal management device 220 may be cycled to a third temperature, wherein the third temperature is different than the first and second temperatures.

Referring now to FIG. 30, another exemplary embodiment of a method of heating a plurality of cells 12 is described. According to the exemplary embodiment reflected in FIG. 30, the fan speed is varied to control the inlet temperature of the heated fluid (in this case, air). The inlet air temperature is generally inversely proportional to the fan speed if the heater temperature is held constant because the temperature of the heated air decreases as it travels at increased speeds. By starting the fan 230 at a relatively high speed and then gradually stepping down the fan speed, the temperature difference between the cells 12 and the air is controlled. As the fan speed is incrementally adjusted from a first, higher speed, to a second, lower speed, the temperature of the heated air is incrementally adjusted from a first, lower temperature, to a second, higher temperature, as shown in FIG. 30. Controlling the temperature difference between the air and the cells 12 limits the temperature difference between the air and the cells 12.

Referring back to FIG. 28, there is a period of time where the relationship between the curves representing the first group or row of cells 211 and the fourth group or row of cells 214 changes from diverging to converging (e.g., at the peak of ΔT, at approximately 45 minutes). According to the embodiment described with respect to FIG. 30, the fan speed is adjusted so that the different groups or rows of cells 211, 212, 213, 214 maintain a similar relationship in FIG. 30 (e.g., as reflected in the successive peaks of ΔT shown in FIG. 30) such that there is less divergence between the temperatures of the various groups or rows of cells 211, 212, 213, 214 and the temperature differences between the different groups or rows of cells remain relatively constant as the cells are heated. As a result, the temperature difference (ΔT) between the first group or row of cells 211 and the fourth group or row of cells 214 is maintained below 5 degrees Celsius.

FIG. 30 shows one exemplary embodiment of stepping down the fan speed (and therefore stepping up the inlet temperature) at specific time intervals (e.g., 5 minutes, 10 minutes, 15 minutes, 20 minutes, 25 minutes, 30 minutes, 35 minutes, 40 minutes, 45 minutes, etc.) to control the temperature differences between the groups or rows of cells 211, 212, 213, 214. According to other exemplary embodiments, the fan speed may be reduced by smaller steps or after smaller time intervals to vary the incremental increases in temperature of the incoming air. According to still other exemplary embodiments, the fan speed may not be stepped but may be continuously reduced in a smooth (i.e., non-stepped) fashion.

It should be understood that the methods described with respect to FIGS. 29 and 30 may also be applied to a method for cooling a plurality of battery cells within a battery module. For example, the thermal management device 220 (in this case, a cooling device) would be turned on and off intermittently (e.g., at intervals of 5 minutes, 10 minutes, 15 minutes, 20 minutes, 25 minutes, 30 minutes, 35 minutes, etc.) in the beginning of the cooling cycle, changing the input fluid (e.g., air, gas, water, liquid) temperature from one temperature (e.g., the desired final temperature) to another, higher temperature (e.g., the ambient temperature of the uncooled outside air). When the thermal management device 220 is on, the fan 230 would force cooled fluid over the cells 12, which would cause the first group or row of cells 211 to cool faster than the group or row series 214. When the thermal management device 220 is turned off, the fan 230 would force warmer fluid over the cells 12, causing the first group or row of cells 211 to warm while the fourth group or row of cells 214 would warm far less (e.g., as a result of the warmer fluid being cooled as it passed over the first/second/third group or row of cells 211, 212, 213).

After a predetermined period of time, the thermal management device 220 may be left on for the remainder of the cooling process (e.g., after 40 minutes, 50 minutes, etc.). It is expected that this cooling method will result in a lower maximum temperature difference between the cells than the method of running the cooling device at a preset temperature and the fan 230 at a preset speed. The alternating streams of cooled fluid and warmer (e.g., ambient) fluid would serve to equalize the temperatures of the cells 12, and the resulting maximum temperature difference would be reduced. Periodically forcing warm air over the cells 12 also reduces the temperature gradient between the outside surface of an individual cell 12 and the center of the cell 12 that may develop during the heating cycle, which may increase battery life.

According to other exemplary embodiments, the length of time the thermal management device 220 is turned on and off in a cooling method may be changed to cool the cells 12 more quickly or to reduce the temperature difference between the cells, depending on the particular application. Furthermore, rather than turning the thermal management device 220 on and off, the thermal management device 220 may remain on and be cycled between a lower temperature and a higher temperature.

Another exemplary embodiment of a method of cooling a plurality of cells 12 is described. Similar to the heating method shown in FIG. 30, in a cooling method the fan speed is varied to control the inlet temperature of the cooled fluid. The inlet fluid temperature is generally inversely proportional to the fan speed if the cooling device temperature is held constant because the temperature of the cooled fluid increases (warms) as it travels at increased speeds. By starting the fan 230 at a relatively high speed and then gradually stepping down the fan speed, the temperature difference between the cells 12 and the fluid is controlled. As the fan speed is incrementally adjusted from a first, higher speed, to a second, lower speed, the temperature of the cooled fluid is incrementally adjusted from a first, higher (warmer) temperature, to a second, lower (cooler) temperature. Controlling the temperature difference between the air and the cells 12 limits the temperature difference between the air and the cells 12.

According to an exemplary embodiment, a method of heating or cooling a plurality of battery cells within a battery module includes forcing fluid across a device (e.g., a thermal management device) and directing the fluid into an inlet of the battery module such that the fluid flows proximate the plurality of cells to modify the temperature of the cells. The thermal management device is intermittently powered on and off so as to provide thermally conditioned (e.g., heated or cooled) fluid across the plurality of cells when the thermal management device is turned on and to provide air at a second temperature (lower temperature if heating, higher temperature if cooling) when the thermal management device is turned off. The second temperature may be, e.g., at a substantially ambient temperature when the thermal management device is turned off. Additionally, the thermal management device may be configured to provide the fluid to the inlet of the battery module at a third temperature different than the first and second temperatures (e.g., running the device at various power outputs to vary the temperature of the fluid).

According to various exemplary embodiments, the thermal management device may be powered or turned on or off at scheduled or regular intervals (e.g., 10 minutes, 15 minutes, 20 minutes, etc.). According to another exemplary embodiment, rather than intermittently powering the thermal management device on and off, the thermal management device is cycled between a first temperature and a second temperature. For heating, the first temperature may be higher than the second temperature. For cooling, the first temperature may be lower than the second temperature.

According to another exemplary embodiment, a method of heating or cooling a plurality of battery cells within a battery module includes thermally conditioning (e.g., heating or cooling) air using a thermal management device, forcing the thermally conditioned air over the plurality of battery cells using a fan, and decreasing the speed of the fan at predetermined intervals and by predetermined amounts such that the temperature of the air forced over the battery cells varies inversely with the speed of the fan. According to an exemplary embodiment, the fan speed is decreased such that the temperature of the thermally conditioned air is changed (e.g., increased for heating, decreased for cooling) approximately 5 degrees Celsius every 40 minutes. According to various other exemplary embodiments, other temperature adjustment values and/or time intervals may be used.

According to various other exemplary embodiments, other methods may be used to provide even heating or cooling among battery cells. For example, an exemplary method may include a combination of the methods illustrated with respect to FIGS. 29 and 30. For example, the power to the thermal management device and the fan speed may be controlled simultaneously to provide even more control over the heating or cooling of the cells and to further minimize the temperature differences between individual cells during heating or cooling. Furthermore, the specific parameters used (e.g., thermal management device temperature, cycling times of the thermal management device, cycling times of the fan, speed of the fan) may be varied to suit particular applications according to various exemplary embodiments.

According to an embodiment of the invention a method of managing the temperature of a plurality of cells within a battery module includes directing a fluid past a device configured to modify the temperature of the gas. The fluid is directed into an inlet of the battery module such that the fluid flows proximate the plurality of cells to modify the temperature of the cells. The device is configured such that the fluid enters the inlet at a first temperature during a first period and at a second temperature during a second period, the first temperature being different from the second temperature. The temperature difference between a first group of cells closest to the inlet and a second group of cells furthest from the inlet is less than it would be if the fluid were provided into the battery module at a constant temperature. The device may be configured such that the fluid enters the inlet at a third temperature during a third period, the third temperature being different from the first temperature and the second temperature.

It should be noted that references to “front,” “rear,” “top,” and “base” in this description are merely used to identify various elements as are oriented in the FIGS., with “front” and “rear” being relative to the environment in which the device is provided.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is important to note that the construction and arrangement of the battery system as shown in the various exemplary embodiments is illustrative only. Although only a few embodiments have been described in detail in this disclosure, those skilled in the art who review this disclosure will readily appreciate that many modifications are possible (for example, variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present embodiments.

1-39. (canceled)

40. A battery module comprising:
a plurality of cells each having a first end and a second end, with a first terminal and a second terminal extending from the first end;
a first tray configured to receive a first row of the plurality of cells and a second row of the plurality of cells such that the first row of cells is separated from the second row of cells by a space; and
a second tray provided adjacent the first tray;
wherein the first row of cells and the second row of cells are arranged between the first and second trays with the terminals of the first row of cells facing away from the terminals of the second row of cells such that the second ends of the cells in the first row of cells face the second ends of the cells in the second row of cells.

41. The battery module of claim 40, further comprising a buss bar assembly coupled to the terminals of the plurality of cells and comprising a plurality of buss bars for connecting the terminals of the cells to each other.

42. The battery module of claim 40, wherein the first and second trays each have a plurality of alternating depressions and ridges configured to receive the plurality of cells.

43. The battery module of claim 40, wherein the first and second trays each comprise a plurality of grooves provided on an edge of each of the trays and configured to receive the terminals of the plurality of cells, wherein the grooves are configured to receive the cells only in the correct orientation.

44. The battery module of claim 40, further comprising a third tray provided between the first tray and second tray and configured to receive a plurality of cells both above and below the third tray.

45. The battery module of claim 40, wherein each of the first and second trays further comprise at least one opening that is configured to facilitate a flow of a fluid between the plurality of cells.

46. The battery module of claim 45, further comprising a housing configured to substantially enclose the plurality of cells and comprising a first opening and a second opening, wherein the housing is configured to allow the fluid to enter the first opening and a first plenum space located adjacent the first row of cells and to exit the housing through the second opening after traveling through the at least one opening in the first and second trays and between the plurality of cells.

47. The battery module of claim 46, wherein the first plenum space has a plurality of features intended to balance the flow of the fluid through the plurality of cells.

48. The battery module of claim 46, wherein the housing further comprises a protrusion configured to isolate a first main terminal of the battery module from a second main terminal of the battery module.

49. The battery module of claim 48, wherein the protrusion is shaped so as to at least partially separate each of the main terminals from one another.

50. The battery module of claim 40, further comprising at least one sealing member coupled to each of the first and second trays to seal the space.

51. A battery module comprising:
a first tray configured to receive a first row of cells and a second row of cells such that the first row of cells are separated from the second row of cells by a space, wherein the cells of the first and second rows are arranged such that terminals of the cells in the first row of cells are accessible at a first side of the tray and terminals of the cells in the second row of cells are accessible at a second side of the tray opposite the first side of the tray.

52. The battery module of claim 51, further comprising a second tray provided adjacent the first tray.

53. The battery module of claim 52, wherein the first and second trays each have a plurality of alternating depressions and ridges configured to receive the first and second rows of cells.

54. The battery module of claim 52, wherein each of the first and second trays further comprise at least one opening that is configured to facilitate a flow of a fluid between at least one of the first and second rows of cells.

55. The battery module of claim 52, further comprising at least one sealing member coupled to each of the first and second trays to seal the space.

56. A battery module comprising:
a plurality of cells, each of the plurality of cells having a terminal at a first end thereof;
a first tray; and
a second tray provided adjacent the first tray;
wherein the plurality of cells are arranged between the first and second trays such that the terminals of a first group of cells face away from the terminals of a second group of cells such that a space is formed between opposing ends of the first and second groups of cells, the space configured to receive gasses expelled from any of the plurality of cells.

57. The battery module of claim 56, wherein each of the first and second trays further comprise at least one opening that is configured to facilitate a flow of a fluid between the plurality of cells.

58. The battery module of claim 57, further comprising a device configured to modify the temperature of the fluid, wherein the device is configured such that the fluid enters the battery module at a first temperature during a first period and at a second temperature during a second period, the first temperature being different from the second temperature.

59. The battery module of claim 58, wherein the device is configured to turn on and off at scheduled intervals.
